(19) United States
(12) Patent Application Publication
(10) Pub. No.: US 2003/0208418 A1
(43) Pub. Date: Nov. 6, 2003

(54) Part sequencing system

(76) Inventors: Daniel Paul Caputo, Attica, MI (US); Thomas W. McKeown, Oxford, MI (US); Stephen M. Hull, Clinton, MI (US); Michael Kearns, Washington, MI (US); Thomas J. Morrison, Brighton, MI (US); Michael G. Khoury, Fraser, MI (US); Murthy N. Guduguntla, Troy, MI (US)

Correspondence Address: Steven J Grossman, Grossman Tucker Perreault & Pfelger, 55 South Commercial Street, Manchester, NH, 03101, US

(21) Appl. No.: 10/275,082

(22) PCT Filed: May 14, 2001
(86) PCT No.: PCT/US01/15565

(51) Int. Cl. G06F 17/60

(52) U.S. Cl. 705/28

(57) ABSTRACT

A part sequencing system is shown that can receive requests for a plurality of inventory items to be supplied in a specified order. The specified order is related to the order in which the inventory will be consumed in a selected manufacturing process. The system may utilize object oriented programming to reduce input errors.

The present invention relates to a part sequencing system which is designed to provide a manufacturer with a standard baseline system to sequence parts to customers pursuant to any given assembly sequence. Accordingly, the system herein has the ability to be customized for any given site assembly sequence, via the use of object oriented programming techniques and set-up files. The system herein possesses the ability to transmit via the Internet messages containing pertinent manufacturing data or events to any number of authorized clients. Clients herein include other part sequencing systems, ERP systems, data bases, browsers, etc. These messages allow the user of the software to manage their inventory and product flow throughout the supply chain.

A variety of disclosures have surfaced in the part few years dealing with efforts to automate inventory control. For example, in U.S. Pat. No. 5,644,725, entitled “Computerized Inventory Monitoring and Verification System and Method” there is disclosed a system and method for monitoring and verifying inventory. The system comprises a portable computer and modem all “cabled” together and maintained in a carrying case. The portable computer communicates with a mainframe computer on which certain dealer inventory information is maintained. Software, residing on a disk which is accessible by the portable computer, allows for the input of dealer codes which are used to identify inventory information which is downloaded from the mainframe computer to the portable computer. The inventory information is used to support an audit of the dealer's inventory. The system provides an auditor with an up-to-date record of a dealer's current inventory. The system also provides the auditor with a device for printing out a checklist for use in undertaking the inventory, for preparing reconciliation reports for verifying the auditor's findings with the dealer and an input for inputting the results of the inventory. Ultimately, a final inventory report can be printed which includes the present status of all inventory items and any and all charges collected.

In United States Statutory Invention Registration H1743, entitled “Inventory Management Method and Apparatus”, there is disclosed a method and apparatus for inventory monitoring a supply consumed in the manufacturing of a finished product. An inventory management system monitors the quantity of supplies in a storage facility. Based upon historical data related to the rate of usage of supplies, the inventory management system determines the period of time until the stored supplies are depleted. If the supplies are depleted prior to a next scheduled delivery of replacement supplies, the inventory management system communicates with the supplier to move ahead the delivery date. Conversely, if the inventory management system determines that supplies are being consumed at a rate lower than projected, the inventory management system will instruct the supplier to delay a shipment date. Personnel may access the system from a local location or remote location. In addition, an alarm is activated when there is a sudden change in the rate of usage of the stored supplies. Provisions are included for detecting the receipt of replacement supplies in order to authorize payment.

Attention is also directed to U.S. Pat. No. 6,049,742, entitled “Projected Supply Planning Matching Assets with Demand in Microelectronics Manufacturing”. As recited therein, a system is disclosed related to computer-implemented planning resources and decision-support tools and, more particularly, to a tool in which core production planning information is provided to a solver which generates a feasible projected supply plan (PSP) that meets user guidelines. The system is said to generate an intelligent PSP match between existing assets and demands across multiple manufacturing facilities within the boundaries established by the manufacturing specifications, process flow and business policies.

As can therefore be seen from the above, various industries are exploring new techniques to develop computer-based methodology to improve inventory monitoring. Along such lines, on-going efforts are directed at the development of better and more flexible procedures for manufacturers to automate their communication to a given supplier such that a supplier can more efficiently sequence and deliver parts in actual assembly sequence.

For example, the current trend in the automotive industry is to reduce inventory and costs by outsourcing component assembly work. Outsourcing assembly work reduces the work force requirements of the OEM assembly plant. To accomplish the goal of reduced inventories, these assemblies are then sent to the assembly plant in the order in which they will be consumed. Receipt of material in the order it is used on the assembly line eliminates the need for inventory at the work station. This method of ordering, called “sequencing” has therefore moved “Just-in-Time” to a next and higher level of inventory administration.

Accordingly, it is an object of this invention to recognize the above referenced industry development regarding sequencing, and to develop a part sequencing system (PSS) to provide a manufacturer with a standard baseline system to sequence parts to the customer in accordance with customer assembly sequence requirements.

In addition, it is also an object of this invention to develop such a PSS which will provide a more cost effective system that can be employed by all manufacturing operations in a given company, regardless of the end customer and such customer's particular requirements.

It is also an object of this invention to develop a PSS which will improve the shipment accuracy of the manufacturer and therefore increase end customer satisfaction, and which will simultaneously provide a system with increased uptime, and a system which does not force an individual manufacturing site to use a particular type of hardware, but which allows each individual manufacturer to select any given hardware as may be desired.

Finally, in addition to the above, it is also an object of this invention to develop such PSS which can be customized to fill each manufacturing site's specific needs, and to include a variety of options for the manufacturer through the use of such features as object oriented programming techniques and set-up files.

In accordance with the present invention, there is provided a system and method for sequencing parts to customers in assembly sequence. Accordingly, the present invention comprises a supply monitoring and delivery system comprising a central computer system comprising a central processing means for receiving and collecting manufacturing assembly data from a plurality of customers in customer specified assembly sequence. The central processing means contains means for storing said collected data in said customer specified assembly sequence. In addition, the system herein contains a means for outputting said collected data in said customer specified assembly sequence. The outputting of said collected data includes, but is not limited to, customer specific part assembly sequence requirements, such as selection of the appropriate parts from inventory, the packaging and shipping such parts in containers in a customer desired order, and/or the creation of bar coding labels for the parts. In such fashion, the verification of packing sequence by scanning of the bar code labeling is made possible, therein insuring that shipments to the customer have no mislabels and/or out-of-sequence part delivery.

Accordingly, in one embodiment, the present invention comprises a supply monitoring and delivery system, comprising a central computer system comprising a central processing means for receiving and collecting manufacturing assembly data in a customer specified assembly sequence from a plurality of customers, the central processing means comprising a means for storing said collected data, and a means for outputting said collected data, the outputting of said collected data comprsing customer specific part assembly sequence requirements.

In a second embodiment, the present invention comprises a part sequencing system, comprising a receiver for receiving customer requirements and an indication of the order in which the requirements will be consumed, a database coupled to the receiver for storing the customer requirements and the indication of the order in which the requirements will be consumed, a program for generating a packaging sequence based on the customer requirements and the indication of the order in which the requirements will be consumed, an output device for communicating the packaging sequence in order to package the customer requirements in a container, an output device for generating a sequence identifier for the container based on the order in which th e requirements will be consumed, and an input device for scanning the sequence identifier and an item identifier to confirm the item is in a proper sequenced container.

In a third embodiment the present invention also comprises a method of sequencing parts, comprising the steps of receiving a request for a plurality of items of inventory to be delivered in a specified sequence, retrieving the items from inventory, packaging the items of inventory in a container, labeling the container with a sequence identifier, and loading the containers on a vehicle based on the sequence identifier.

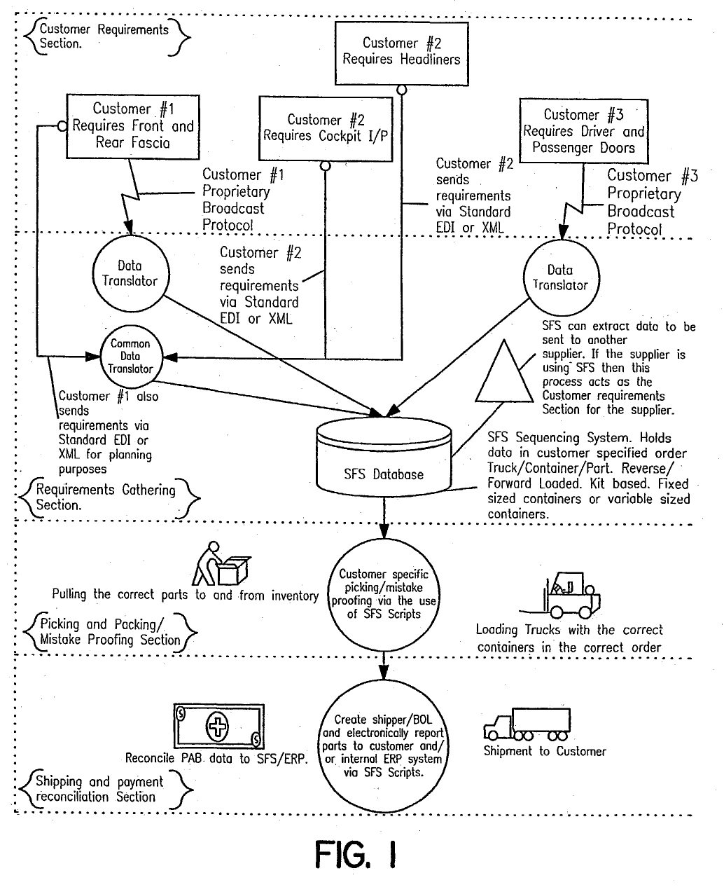

FIG. 1 is a block diagram of the part sequencing system according to a preferred embodiment of the invention.

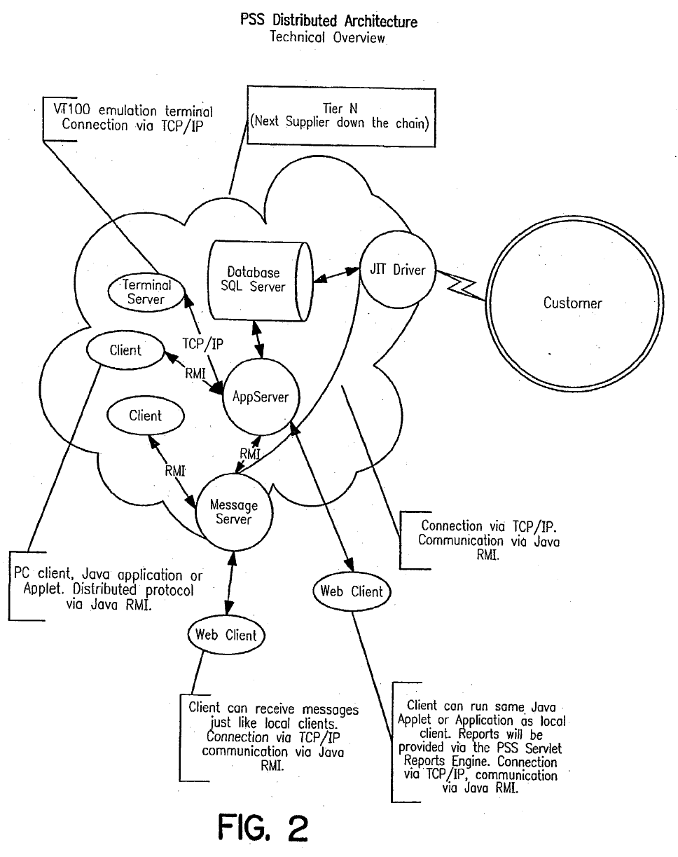

FIG. 2 is a block diagram providing a technical overview of the part sequencing system of the present invention.

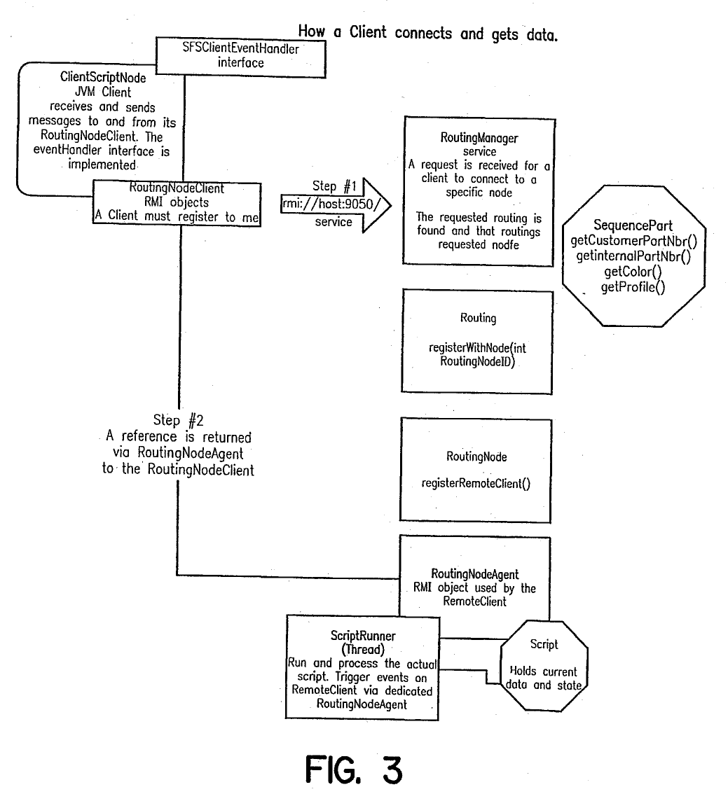

FIG. 3 illustrates how a client of the part sequencing system obtains access to data.

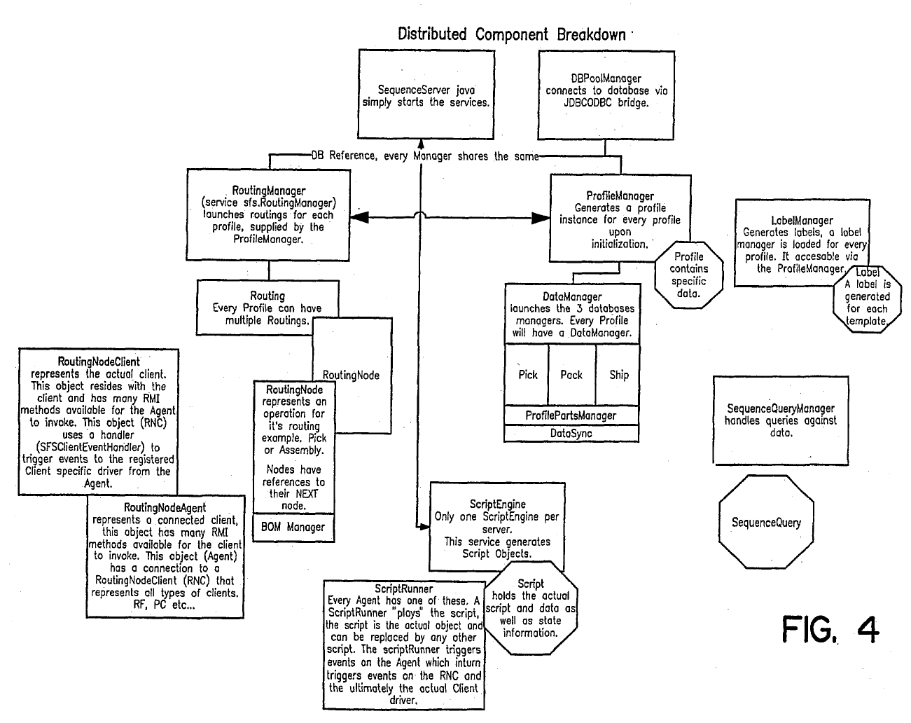

FIG. 4 illustrates the different objects of the part sequencing system distributed system.

To illustrate the features of the invention, reference is made to the sequencing of parts from an automotive supplier to an OEM. This reference should not be construed as a limitation on the application of this system and method to other manufacturing situations.

As noted above, the overall system and method of the present invention provides a PSS for a manufacturer thereby creating the ability to sequence parts to a plurality of customers in accord with customer manufacturing assembly sequence. The system herein has the ability to be customized to fill each customer's site-specific needs. Through the use of the invention's scripting language, each manufacturing site has the ability to decide which business rules will be enabled for a given process. For example, customer #1 requires each truck to be loaded so that when it arrives at the customer facility, the first part off the truck is' the lowest sequence number (first to be produced from this delivery). Conversely, Customer #2 wants the first part off the truck to be the highest sequence number (last one in this delivery to be produced). This invention allows the manufacturer to satisfy both customer #1 and customer #2's requirements simultaneously with a single system. In fact, differing manufacturing processes can be utilized in conjunction with the differing customer requirements. Using the previous example, differing degrees of mistake proofing can be incorporated into the system by requiring part verification scanning or other mistake proofing techniques. These internal rules can be blended with customer rules to create the business process that provides the best value.

A unique concept incorporated into the PSS is the method in which the business process customization is attained. Rather than creating specific computer code and setting values (parameters) for all the variables that can be considered of during the design phase, the PSS herein utilizes a script language that allows the end user to create the computer program without programming knowledge. By simply choosing functions that need to be performed, in the order that they need to be performed, the computer code is automatically assembled into a working PSS. This methodology not only makes it easier for the manufacturer to define the business processes required and changes when needed, but it allows for rapid deployment of said systems since there is no customized programming.

The PSS herein may run on a Microsoft Windows NT/2000 platform with a Microsoft SQL Server database. The shop floor terminals may be any computing device that can run a Java Virtual Machine (JVM) or support a Virtual Terminal (VT) emulation such as PC's, thin clients, terminals or RF bar codes scanners.

The PSS herein interfaces with the sequencing center's ERP/MRP (Enterprise Resource Planning/Manufacturing Resource Planning) system or can be used in standalone mode. The PSS is designed to accommodate single data input. Once information has been input, e.g., a new part number into the ERP system, there is no need to have users enter the data into a separate database. This eliminates the costly redundancies of separate databases systems and typing errors made by keyboard input.

As noted, the PSS herein can make use of bar coding to insure accuracy of the shop floor transaction. The creation of labels through the sequencing process and the scanning of product-labels as manufacturing proceeds keeps PSS in communication with actual product assembly. Product found to be defective can now be automatically replaced at the first available opportunity.

In addition, the verification of packing sequence is readily accomplished by scanning of the previously applied bar code labels. This then ensures that shipments to the customer have no mislabels or out-of-sequence part delivery. Furthermore, the PSS herein provides traceability and mistake proofing capability. For example, with respect to traceability, many products that are sequenced have safety-related items installed. Traceability therefore requires that manufacturing process information for safety components be maintained in the event of an accident. The traceability information is now herein conveniently stored in an information database where it is easily accessible if the need arises.

With regards to mistake proofing, such feature now made possible herein, is yet another enhancement to the manufacturing process. In such regard, it can be appreciated that human error accounts for the majority of shipping errors at a given sequencing center. For example, an incorrect part is selected, a label is placed on the wrong shipping container, etc. Via the use of the herein described PSS, in conjunction with bar code scanning and, double user input verification, the system herein prevents users from inadvertent mistakes.

FIG. 1 herein provides a system overview of the present invention, in exemplary embodiment, as applied to different customers in connection automotive assembly manufacture. As shown therein, central to the system is the shop-floor-sequencing (SFS) database, which accepts data in customer specified order. More specifically, and by way of example only, customer #1 is shown as requiring front and rear fascia components, with its own developed proprietary broadcast protocol. Such proprietary broadcast protocol is sent through a data translator directly to the SFS database. Alternatively, customer #1 can also send requirements to the SFS database via standard EDI or XML for planning purposes, wherein such requirement passes through a common data translator.

Simultaneous to the above, customer #2 is shown as requiring a cockpit instrument panel component (IP). Customer #2 can send its requirements via standard EDI or XML, again, through the common data translator and into the SFS database. In addition, customer #2 is shown requiring headliner product, and also sends its requirements though the common data translator into the SFS database. Customer #3 is shown requiring driver and passenger door components, and as indicated, has opted to employ a proprietary broadcast protocol. Accordingly, customer #3's broadcast protocol proceeds through a data translator and then into the SFS database.

With attention directed at the SFS database, it is worth noting that such database may extend into communication with another supplier. If such supplier is making use of the SFS herein, then the SFS acts to simultaneously provide such supplier with the end-user customer requirements. Accordingly, numerous suppliers can be configured to report into the SFS database, so that such suppliers can similarly sequence parts to the customer in desired sequence requirements.

Once all input information is received, the SFS Database can then output customer specific requirements, such as directing the selection and packing of correct parts to and from inventory, as well as the loading of trucks with the correct containers in the correct order, as required by the customer. At such point, the SFS Database can also create corresponding bar coded shipping labels for the selected parts, and electronically report to the customer and or internal ERP system via SFS scripts.

As can therefore be seen from the above, the system herein provides manufacturing sites with a computerized system to provide: VIN sequenced parts to customers via the use of: broadcast signals (standard or non-standard EDI) from the customer; manufacturing requirements based on customer forecast; traceability capability; mistake-proofing capability; pack-out list for container sequencing; bar code scan of parts for correct sequence verification; bar code scan of shipping containers for shipment verification; generations of advanced shipping notices; EDI reporting indicating that parts were consumed in designated sequence.

As noted above, FIG. 2 provides a technical overview of the part sequencing system distributed system. The figure is self-explanatory, in the sense that it illustrates the communication relationships between the different objects of the part sequencing system. The connection requirements are shown to be TCPIP as the “hard” connection and Java RMI as the “soft” connection.

FIG. 3 illustrates how a client of the part sequencing system obtains access to data. The Routing Manager service monitors the network for valid connected clients and keeps track of what data is sent to and received by which client. Remote clients can run systems scripts to decode data and perform actions. The utilization of scripts is a key to the system as it processes data. Scripts will contain data and state variables.

Finally, FIG. 4 shows the different objects of the part sequencing system distributed system. Each object has a specific function that can be utilized by any client of the system. Each object may have specific relationships with other objects. For example, the Label Manager performs the label printing task. The Routing Manager controls information flow throughout the system. The Data Manager is used to control the shop floor and the three primary operations performed on the floor, selecting parts, packing parts, and shipping parts.

What is claimed is:

1. A supply monitoring and delivery system, comprising:
a central computer system comprising a central processing means for receiving and collecting manufacturing assembly data in a customer specified assembly sequence from a plurality of customers, the central processing means comprising a means for storing said collected data, and
a means for outputting said collected data, the outputting of said collected data comprising customer specific part assembly sequence requirements.

2. The supply monitoring and delivery system of claim 1, wherein the specific part assembly sequence requirements comprise a selection of appropriate parts from an inventory.

3. The supply monitoring and delivery system of claim 1, wherein the specific part assembly sequence requirements comprise packaging the parts in containers in a customer desired order.

4. The supply monitoring and delivery system of claim 1, wherein the specific part assembly sequence requirements comprise shipping the parts in a customer desired order.

5. The supply monitoring and delivery system of claim 1, wherein the specific part assembly sequence requirements comprise creating sequence identifying labels for the parts.

6. The supply monitoring and delivery system of claim 5, wherein the sequence identifying labels for the parts are bar codes.

7. The supply monitoring and delivery system of claim 6, wherein the specific part assembly sequence requirements comprise scanning and storing in said central processing means the sequence identifying labels and wherein said central processing means stores an association between said identifying label and said customer specified assembly sequence, and outputting said collected data including said association to said customer.

8. A part sequencing system, comprising:
a receiver for receiving customer requirements and an indication of the order in which the requirements will be consumed,
a database coupled to the receiver for storing the customer requirements and the indication of the order in which the requirements will be consumed,
a program for generating a packaging sequence based on the customer requirements and the indication of the order in which the requirements will be consumed,
an output device for communicating the packaging sequence in order to package the customer requirements in a container,
an output device for generating a sequence identifier for the container based on the order in which the requirements will be consumed, and
an input device for scanning the sequence identifier and an item identifier to confirm the item is in a proper sequenced container.

9. The part sequencing system of claim 8, further comprising a data translator to allow the database to communicate with systems communicating using a proprietary broadcast protocol.

10. The part sequencing system of claim 12, wherein the program utilizes object oriented programming.

11. A method of sequencing parts, comprising the steps of:
receiving a request for a plurality of items of inventory to be delivered in a specified sequence,
retrieving the items from inventory,
packaging the items of inventory in a container,
labeling the container with a sequence identifier, and
loading the containers on a vehicle based on the sequence identifier.

12. The method of sequencing parts of claim 11, wherein the loading of the vehicle comprises the step of loading the containers with the lowest sequence identifiers first.

13. The method of sequencing parts of claim 11, wherein the loading of the vehicle comprises the step of loading the containers with the highest sequence identifiers first.

14. The method of sequencing parts of claim 11, further comprising the step of generating a signal denoting the retrieving of said item from said inventory.

15. The method of sequencing parts of claim 11, further comprising the step of scanning said sequence identifier for said items and comparing said sequenced identifier for said items with said specified delivery sequence to confirm said specified delivery sequence.

16. The method of sequencing parts of claim 15, further comprising the step of generating an advanced shipping notice comprising a listing of said sequence identifiers for said items for said delivery sequence.

17. The method of sequencing parts of claim 11, wherein the specified sequence is directly related to the order in which the items are to be consumed in a manufacturing process.

18. The method of sequencing parts of claim 11, wherein the specified sequence is in accordance with a customer assembly sequence requirement.

19. The method of sequencing parts of claim 18, wherein the customer assembly sequence requirement is correlated to said customer assembly sequence requirement.
